(19) United States
(12) Patent Application Publication
(10) Pub. No.: US 2010/0017749 A1
(43) Pub. Date: Jan. 21, 2010

(54) DISPLAY APPARATUS AND DISPLAY METHOD

(75) Inventor: Young-eun Bang, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/365,468

(22) Filed: Feb. 4, 2009

(30) Foreign Application Priority Data
Jul. 21, 2008 (KR) 10-2008-0070848

(51) Int. Cl. G06F 3/048

(52) U.S. Cl. 715/799

(57) ABSTRACT

A display apparatus includes a display unit which displays an application window, and a control unit which controls the display unit to display the application window with a transition effect when an application window control event occurs. Therefore, it is possible to apply various transition effects other than a transition effect previously stored in an application.

### CROSS-REFERENCE TO RELATED APPLICATIONS

This application claims priority from Korean Patent Application No. 10-2008-0070848, filed on Jul. 21, 2008, in the Korean Intellectual Property Office, the disclosure of which is incorporated herein by reference in its entirety.

### BACKGROUND OF THE INVENTION

1. Field of the Invention

Apparatuses and methods consistent with the present invention relate to providing a display apparatus and display method, and more particularly, to providing a display apparatus which is able to display an application window with transition effects, and a display method of displaying an application window with transition effects.

2. Description of the Related Art

Animation effects such as transition effects, which cause application windows to vary in shape when the state of the application windows change, are available in native applications in the same manner as in application programs provided during installation of Operating Systems (OS). However, in the related art, native applications are programmed in advance and stored in applications, therefore it is impossible to use effects other than the transition effects stored in advance in native applications.

Additionally, the native applications are only able to be applied to corresponding applications, and have no effect on other applications.

Native applications are able to communicate with general applications so external animation effects may be applied to the native applications, but in this situation, virtual machines need to be used, which may cause user inconvenience.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a display apparatus able to display an application window with a transition effect, and a display method thereof.

According to an aspect of the present invention, there is provided a display apparatus comprising a display unit which displays a first application window of a first application, and a control unit which controls the display unit to display the first application window with a transition effect if an application window control event occurs.

The transition effect may be an effect which causes at least one of position, shape, color, and direction of movement, of the first application window to change.

The transition effect may be applied in compliance with a definition in either markup language received from an external server or previously stored markup language.

Application information may contain information on a transition effect applicable to an application window other than the first application window.

The display apparatus may further comprise a storage unit which stores application information which defines the transition effect.

The display apparatus may further comprise a user interface unit which receives a selection of the transition effect from a plurality of transition effects if the plurality of transition effects are applicable to the first application window.

If an event occurs to control an application window of an other application different from the first application, the control unit may control the display unit to display the application window of the other application according to a transition effect suitable for the other application.

If a plurality of applications are linked so as to operate together, and if the application window control event occurs, the control unit may control the display unit to display each application window and corresponding transition effects of the plurality of applications, according to the link between the first application and another application linked to the first application.

The application window may be controlled according to a change in a state of the application window.

According to another aspect of the present invention, there is provided a display method comprising determining whether an application window control event occurs, and displaying a first application window of a first application with a transition effect if it is determined that the application window control event occurs.

The transition effect may be an effect which causes at least one of position, shape, color, and direction of movement, of the first application window to change.

The transition effect may be applied in compliance with a definition in either markup language received from an external server and previously stored markup language.

Application information may contain information on a transition effect applicable to an other application window different from the first application window.

The display method may further comprise storing application information defining the transition effect.

The display method may further comprise receiving a selection of the transition effect one from a plurality of transition effects if the plurality of transition effects are applicable to the first application window.

The displaying may comprise, if an event occurs to control an application window of an other application different from the first application, displaying the application window of the other application according to a transition effect suitable for the other application.

The displaying may comprise, if a plurality of applications are linked so as to operate together, and if the application window control event occurs, displaying each application window and corresponding transition effects of the plurality of applications, according to the link between the first application and another application linked to the first application.

The application window may be controlled according to a change in a state of the application window.

### BRIEF DESCRIPTION OF THE DRAWINGS

The above and other aspects of the present invention will be more apparent by describing in detail exemplary embodiments of the present invention thereof with reference to the accompanying drawings, in which:

FIG. 1 is a block diagram of a display apparatus according to an exemplary embodiment of the present invention;

FIG. 2 is a detailed block diagram of the display apparatus shown in FIG. 1;

FIG. 3 is an exemplary embodiment of markup language received from an external server;

FIGS. 4A to 4D are an exemplary embodiment of an application window displayed with a transition effect;

FIGS. 5A and 5B are an exemplary embodiment of markup language in which a transition effect is defined;

FIG. 6 is an exemplary embodiment of an application window displayed on a display unit;

FIGS. 7A to 7D are an exemplary embodiment of an application window displayed with a transition effect;

FIG. 8 is a flowchart explaining a display method according to an exemplary embodiment of the present invention; and

FIG. 9 is a flowchart explaining in detail the display method of FIG. 8.

### DETAILED DESCRIPTION OF EXEMPLARY EMBODIMENTS OF THE INVENTION

Exemplary embodiments of the present invention will now be described in greater detail with reference to the accompanying drawings.

In the following description, same drawing reference numerals are used for the same elements even in different drawings. The matters defined in the description, such as detailed construction and elements, are provided to assist in a comprehensive understanding of the invention. Thus, it is apparent that the exemplary embodiments of the present invention can be carried out without those specifically defined matters. Also, well-known functions or constructions are not described in detail since they would obscure the invention with unnecessary detail.

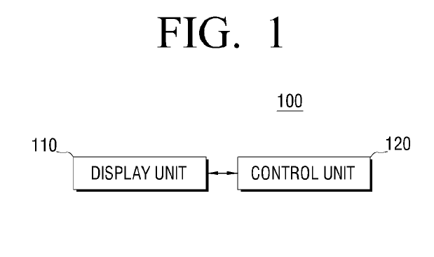

FIG. 1 is a block diagram of a display apparatus 100 according to an exemplary embodiment of the present invention. The display apparatus 100 includes a display unit 110 and a control unit 120.

The display apparatus 100 may be implemented as an apparatus able to receive transition effects from an external server via cable or wirelessly, for example a Digital Television (DTV), a Personal Computer (PC), a Portable Multimedia Player (PMP), a mobile phone, a Personal Digital Assistant (PDA), or an image forming apparatus having a display screen.

The display unit 110 displays an application window. In an exemplary embodiment of the present invention, an application may be, but is not limited to, a web browser such as Netscape or Internet Explorer, or application programs able to run on various Operating Systems (OSes). The application may be, but is not limited to, a widget, such as a news flash widget, a weather widget, or a game widget. Hereinafter, a web browser, an application program and a widget application will all be referred to as an application.

The control unit 120 controls the display unit 110 to display the application window with a transition effect if an application window control event occurs.

The application window control event refers to a situation in which: a user opens an application window by clicking on a shortcut icon on a background screen of a PC, a user closes an activated application window, a user minimizes an activated application window, or a user drags an application window using a mouse. Additionally, if the display apparatus 100 is a DTV, a user may select an “open” or “close” widget window from an on-screen display menu by pressing four directional buttons or a selection button on a remote controller of the DTV to control an application window. Accordingly, it is possible to control the application window according to a change in the state of the application window.

Here, transition effects may be, but are not limited to, effects which cause at least one of position, shape, color, and direction of movement, of the application window to change in a stored pattern. Such transition effects may include movement effects and rotation effects. If a movement effect is added to a display screen, namely the application window of the display unit 110, the application window may be displayed while moving along a path defined in markup language. If a rotation effect is added to the display unit 110, an application window may be generated on a portion of the display unit 110 and may be displayed while rotating. Additionally, transition effects may cause the application window to become transparent (namely, a transparent effect), or allow the size of the application window to be increased or reduced. Furthermore, it is possible to simultaneously apply two or more effects, for example, the rotation effect may be applied together with a color change effect. Such transition effects generally refer to animation effects.

The transition effect may be applied to an application window complying with content defined in either markup language received from an external server or markup language that has been previously stored inside the display apparatus 100 after being received from an external server. The transition effect may be implemented using markup language such as Extensible Markup Language (XML) or Hypertext Markup Language (HTML).

Application information may include information regarding an updating period, information regarding a transition effect, information regarding an Identification (ID) of an application window to which the transition effect is to be applied, or information required for launching an application. The application information may be all types of information capable of being received from an external server or hub site and used in a selected application. In this situation, the display apparatus 100 may receive the application information from the external server through a network interface unit (not shown). The network interface unit (not shown) may be a Network Interface Card (NIC).

Additionally, the application information may contain a transition effect applicable to an application other than the selected application, further description of which will be made later.

A plurality of applications may be linked so as to operate together, for example, the selected application opening in a window causes a window of the other application to be closed. In this example, if an event occurs to control an application window of one of the plurality of applications, the control unit 120 controls the display unit 110 to display each of the application windows of the plurality of applications while showing transition effects, according to the stored link between the application in which the event occurred and another application linked to the application.

In the exemplary embodiment, the same transition effect may be applied to each of the application windows of the plurality of applications, or different transition effects may be applied to each of the application windows of the plurality of applications. Additionally, various transition effects may be set to each of the application windows of the plurality of applications in a random manner.

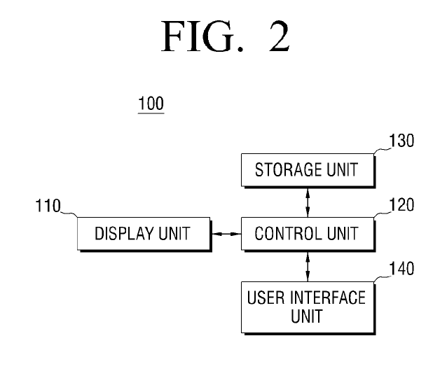

FIG. 2 is a detailed block diagram of the display apparatus 100 shown in FIG. 1. The display apparatus 100 of FIG. 2 includes a storage unit 130 and a user interface unit 140 in addition to the display unit 110 and control unit 120.

The storage unit 130 stores application information which defines a transition effect. As described above, the transition effect applicable between the plurality of applications may be previously stored in the storage unit 130.

If an event occurs to control a window of an application other than the selected application, then the control unit 120 controls the display unit 110 to display the window of the other application with a transition effect suitable for the other application, further description of which will be given later.

The user interface unit 140 provides a user interface window through which a user may select a transition effect from a plurality of transition effects if the plurality of transition effects are applicable to the selected application. For example, if the movement effect and rotation effect applied to the selected application are stored in the storage unit 130, the user interface unit 140 may display a user interface window on the display unit 110 in order to let the user select either the movement effect or rotation effect.

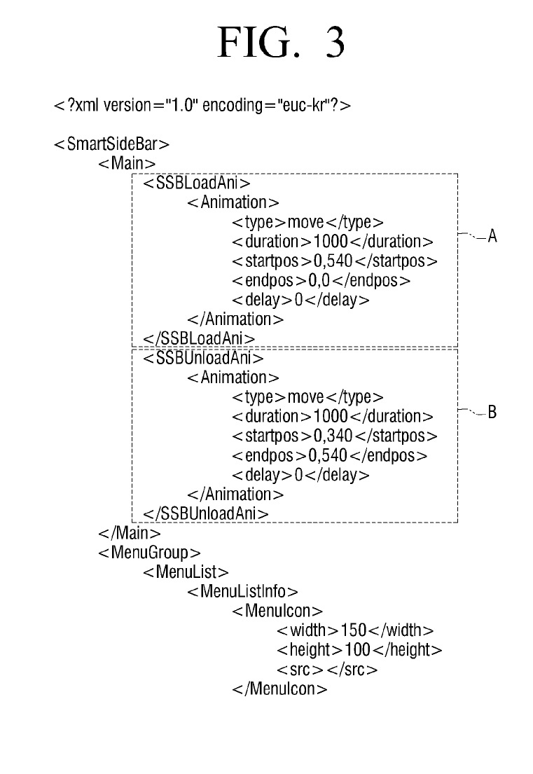

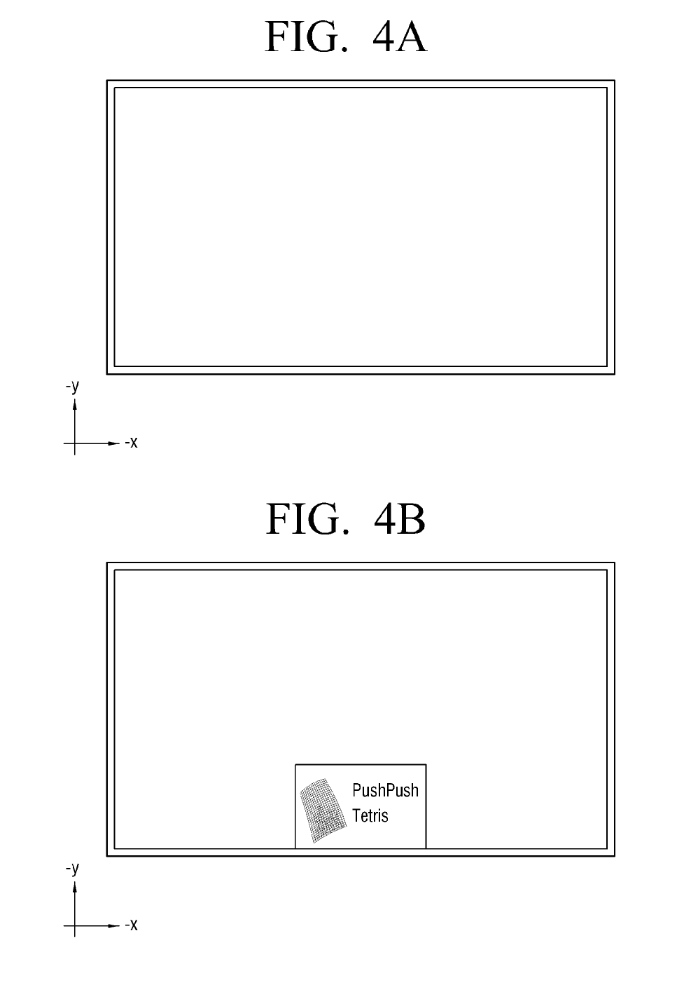

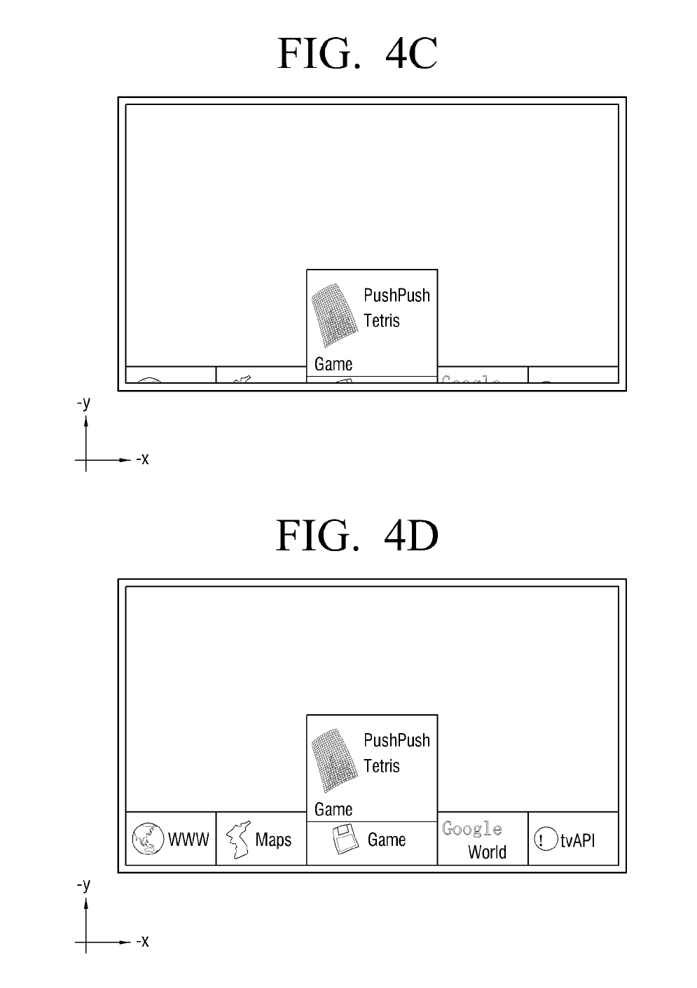

FIG. 3 is an exemplary embodiment of markup language received from an external server, and FIGS. 4A to 4D are exemplary embodiments of an application window displayed with a movement effect.

Referring to FIG. 3, information on a “SmartSideBar” application is received in XML, which may be the sort of markup language, from an external server or hub site in the form of a predetermined file. In this exemplary embodiment, information required to apply the movement effect may be interpreted through a parsing operation or rendering operation, and may be stored in a widget engine. Here, the widget engine may be, but is not limited to, the control unit 120 or the storage unit 130.

As shown in box A of FIG. 3, the movement effect is defined in a <type> tag. Additionally, 1000 (one second) is defined in a <duration> tag, so the transition effect may last one second. Values of (0, 540), (0, 0) and 0 are defined in a <startpos> tag, an <endpos> tag and a <delay> tag, respectively. Furthermore, the distance between the start position and the end position is displayed in the box A.

Referring to FIGS. 4A to 4D, an application window is gradually displayed with the movement effect. Since coordinates of the start position and end position are (0, 540) and (0, 0), respectively, based on the axis of coordinates shown in FIGS. 4A to 4D, the application window moves up as shown in FIGS. 4A to 4D.

The start position and end position may have various coordinate values, so an application window with the movement effect may be displayed moving in various directions. For example, the application window may be displayed moving from left to right, from right to left, from top to bottom, or from bottom to top.

Additionally, if coordinates of an intermediate position between the start position and end position are added, the application window with the movement effect may be displayed while sequentially moving from the start position to the end position via the intermediate position.

If the “SmartSideBar” application written in the markup language of the box A of FIG. 3 is opened, the application window may be displayed while moving gradually from bottom to top as shown in FIGS. 4A to 4D. Alternatively, if a “SmartSideBar” application written in the markup language of box B of FIG. 3 is closed, the application window may be displayed while moving from top to bottom.

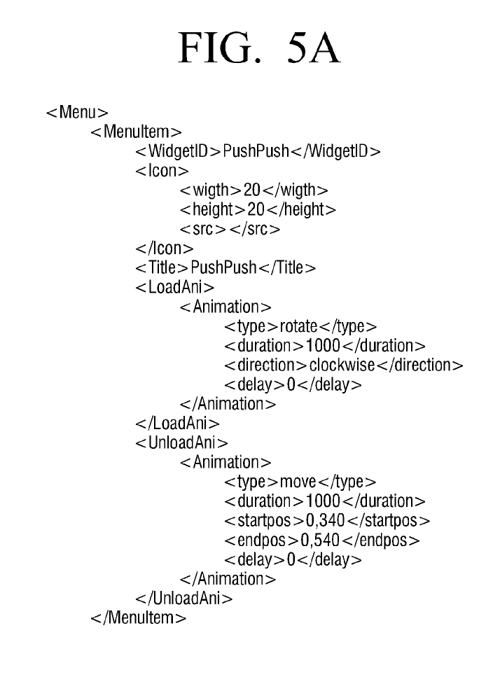

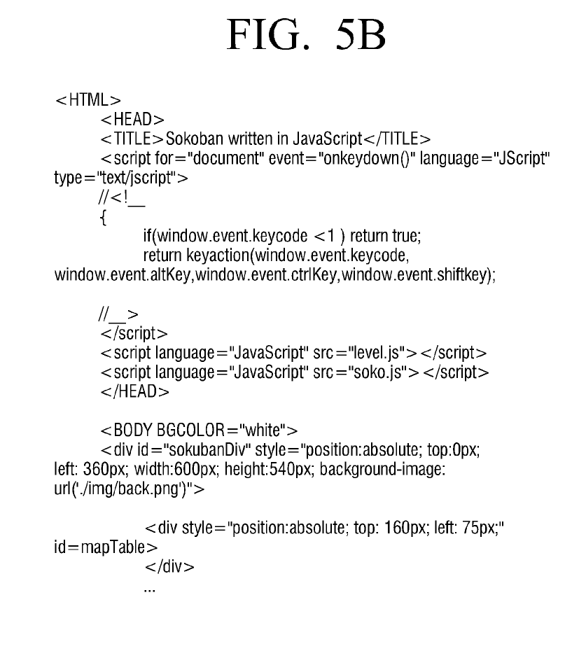

FIGS. 5A and 5B is an exemplary embodiment of markup language in which a transition effect is defined.

Referring to FIG. 5A, if information regarding a “SmartSideBar” application is received, a transition effect suitable for a “PushPush” application window may also be received together with the information. If an application ID is defined in the markup language, it is possible to check which application corresponds to the transition effect defined in markup language.

Alternatively, when the information regarding the “SmartSideBar” application is received as shown in FIG. 5A, a transition effect for the “SmartSideBar” application may not be defined in the information. Accordingly, if an event to control a window of the “SmartSideBar” application occurs, the window of the “SmartSideBar” application may be displayed without a transition effect. The transition effect for the “PushPush” application may be stored in the storage unit 130.

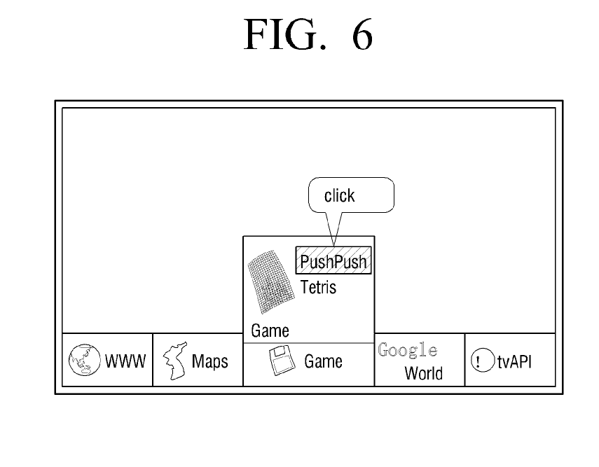

FIG. 6 is an exemplary embodiment of an application window displayed on the display unit 110. The application window shown in FIG. 6 provides information regarding the Internet, maps, and games, among other information, using the “SmartSideBar” application. The application window of FIG. 6 may function as a toolbar or may be used as a link application for launching another application.

If a user selects a button to launch the “PushPush” application through the “SmartSideBar” application window as shown in FIG. 6, an event may occur to control the “PushPush” application window. In this situation, the markup language shown in FIG. 5B for launching the “PushPush” application may be parsed using the transition effect suitable for the “PushPush” application window previously stored in the storage unit 130 according to the markup language shown in FIG. 5A. Accordingly, it is possible to display the “PushPush” application window with a selected transition effect. Therefore, it is also possible to implement a transition effect suitable for an application window other than using the transition effect for the selected application.

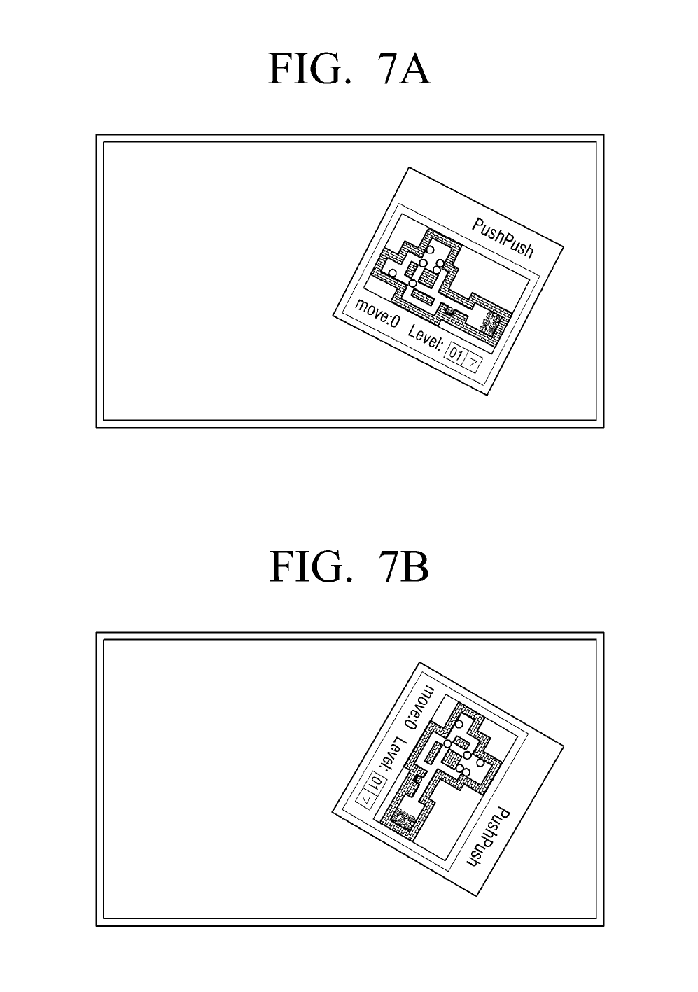

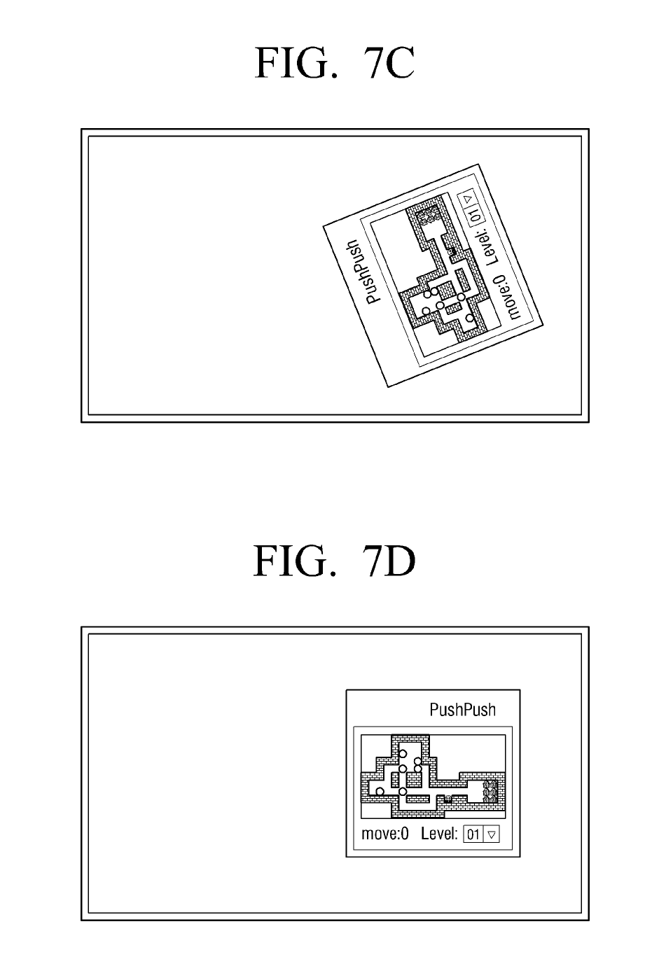

FIGS. 7A to 7D are an exemplary embodiment of “PushPush” application window displayed on the display unit 110 with a rotation effect. The rotation effect is defined in the markup language shown in FIG. 5A as a clockwise rotation of an application window lasting about one second. The rotation effect is received together with the information regarding the “SmartSideBar” application, but the application window shown in FIGS. 7A to 7D may be displayed with the rotation effect defined in the markup language of FIG. 5A according to an execution of a link application for launching another application. As shown in FIGS. 7A to 7D, the “PushPush” application window is displayed on the display unit 110 while rotating.

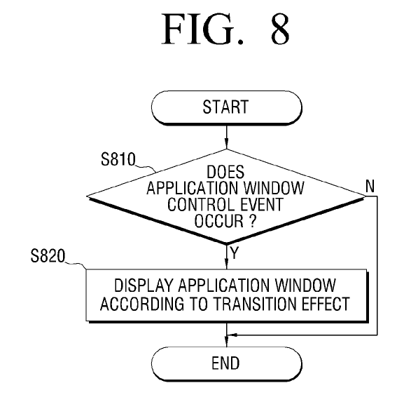

FIG. 8 is a flowchart explaining a display method according to an exemplary embodiment of the present invention. The display method of FIG. 8 includes determining whether an application window control event occurs (S810), and displaying an application window with a transition effect if it is determined that the application window control event occurs (S820).

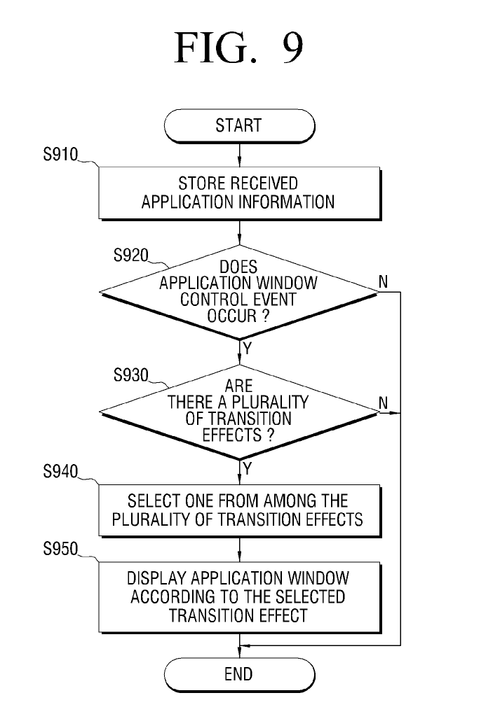

The display method of FIG. 8 is described in detail with reference to FIG. 9. In FIG. 9, the display apparatus 100 stores received application information (S910), and determines whether an application window control event occurs (S920). If it is determined that the application window control event occurs (S920-Y), the display apparatus 100 determines whether there are a plurality of transition effects suitable for a selected application (S930).

If it is determined that the plurality of transition effects suitable for the selected application are stored in the display apparatus 100 (S930-Y), the display apparatus 100 receives a transition effect selection from the plurality of transition effects via a user interface window (S940). Subsequently, the display apparatus 100 displays an application window according to the selected transition effect (S950).

As described above, according to the exemplary embodiment of the present invention, application information in which a transition effect is defined in markup language may be received from an external server, so it is possible to apply various transition effects other than a transition effect previously stored in an application.

Meanwhile, the exemplary embodiments of the present invention previously described may be prepared as a program that can be executed in computers, and may be implemented in universal digital computers which runs the program that is recorded on a computer readable recording medium.

Examples of computer readable recording media include magnetic storage media (such as ROM, floppy disk, hard disks, etc.), and optical recording media (such as CD-ROM, DVD, etc.).

The invention can also be embodied as computer readable codes on a computer readable transmission medium. Examples of the computer readable transmission medium include carrier waves (such as data transmission through the Internet).

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A display apparatus, comprising:
a display unit which displays a first application window of a first application; and
a control unit which controls the display unit to display the first application window with a transition effect if an application window control event occurs.

2. The display apparatus as claimed in claim 1, wherein the transition effect causes at least one of position, shape, color, and direction of movement, of the first application window to change.

3. The display apparatus as claimed in claim 1, wherein the transition effect is applied in compliance with a definition in either markup language received from an external server or previously stored markup language.

4. The display apparatus as claimed in claim 1, wherein application information contains information on a transition effect applicable to an application window other than the first application window.

5. The display apparatus as claimed in claim 1, further comprising:
a storage unit which stores application information which defines the transition effect.

6. The display apparatus as claimed in claim 1, further comprising:
a user interface unit which receives a selection of the transition effect from a plurality of transition effects if the plurality of transition effects are applicable to the first application window.

7. The display apparatus as claimed in claim 5, wherein, if an event occurs to control an application window of an other application different from the first application, the control unit controls the display unit to display the application window of the other application according to a transition effect suitable for the other application.

8. The display apparatus as claimed in claim 1, wherein, if a plurality of applications are linked so as to operate together, and if the application window control event occurs, the control unit controls the display unit to display each application window and corresponding transition effect of the plurality of applications, according to the link between the first application and another application linked to the first application.

9. The display apparatus as claimed in claim 1, wherein the application window is controlled according to a change in a state of the application window.

10. A display method, comprising:
determining whether an application window control event occurs; and
displaying a first application window of a first application with a transition effect if it is determined that the application window control event occurs.

11. The display method as claimed in claim 10, wherein the transition effect is an effect which causes at least one of position, shape, color, and direction of movement, of the first application window to change.

12. The display method as claimed in claim 10, wherein the transition effect is applied in compliance with a definition in either markup language received from an external server or previously stored markup language.

13. The display method as claimed in claim 10, wherein application information comprises information on a transition effect applicable to an other application window different from the first application window.

14. The display method as claimed in claim 10, further comprising:
storing application information defining the transition effect.

15. The display method as claimed in claim 10, further comprising:
receiving a selection of the transition effect from a plurality of transition effects if the plurality of transition effects are applicable to the first application window.

16. The display method as claimed in claim 14, wherein the displaying comprises, if an event occurs to control an application window of an other application different from the first application, displaying the application window of the other application according to a transition effect suitable for the other application.

17. The display method as claimed in claim 10, wherein the displaying comprises, if a plurality of applications are linked so as to operate together, and if the application window control event occurs, displaying each application window and corresponding transition effect of the plurality of applications, according to the link between the first application and another application linked to the first application.

18. The display method as claimed in claim 10, wherein the application window is controlled according to a change in a state of the application window.
